(19) United States
(12) Patent Application Publication
(10) Pub. No.: US 2003/0002092 A1
(43) Pub. Date: Jan. 2, 2003

(54) System, method and adapter for scanning a roll of transparent media

(76) Inventors: Kirk Steven Tecu, Greeley, CO (US); William Robert Haas, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 09/894,326

(22) Filed: Jun. 28, 2001

(51) Int. Cl. H04N 1/04; H04N 1/46

(52) U.S. Cl. 358/506; 358/498

(57) ABSTRACT

A media adapter operable to expose a portion of a roll of media having an end attached to a gatherer included in the adapter and automatically forward a predefined length of the media for exposing sequential portions thereof is provided. A method of scanning images on a media includes exposing a first portion of the media having a predefined length, transmitting light to the first portion and advancing the media to expose a subsequent portion is provided. A scanner system for scanning images on a roll of media including a reflective scanner and a media adapter that includes a mount for holding the roll of media, a gatherer for holding an end of the media, and a feed mechanism that advances a predefined length of the media onto the gatherer thereby exposing a subsequent portion of the media is provided.

### TECHNICAL FIELD OF THE INVENTION

This invention relates to optical scanners and, more particularly, to a system and method of digitally imaging a roll of media.

### BACKGROUND OF THE INVENTION

Document scanners convert an image on a document, photograph or a transparent media into an electronic form suitable for copying, storing and processing by a computer. A document scanner may be a stand-alone device or integrated with a copier, a facsimile machine, or a multipurpose device. Documents to be scanned may generally be classified as either transparent or opaque media.

Typical scanning systems include templates for inserting transparent media therein. The templates are typically dimensioned to ensure a consistent and proper placement of the transparent media on the scanner platen. Transparent media are secured in an insert area of the template and the template is then placed on the scanner platen. However, because the insert area of the template can only accommodate a predefined length of the transparent media, typically three or four image frames, film negatives are first cut into segments of a predefined length having one or more frames per segment. Each segment is then scanned in separate operations. Accordingly, imaging a complete roll of film negatives, for example twenty-four or thirty-six frames, requires many repetitive manual steps of loading film segments into the template followed by a scan of the segment. Such a procedure is time consuming and cumbersome.

### SUMMARY OF THE INVENTION

In accordance with an embodiment of the present invention, a media adapter operable to expose a portion of a roll of media having an end attached to a gatherer included in the adapter and automatically forward a predefined length of the media for exposing sequential portions thereof is provided.

In accordance with another embodiment of the present invention, a method of scanning images on a media includes exposing a first portion of the media having a predefined length, transmitting light to the first portion and advancing the media to expose a subsequent portion is provided.

In accordance with another embodiment of the present invention, a scanner system for scanning images on a roll of media including a reflective scanner and a media adapter that includes a mount for holding the roll of media, a gatherer for holding an end of the media, and a feed mechanism that advances a predefined length of the media onto the gatherer thereby exposing a subsequent portion of the media is provided.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 is a perspective view of a document scanner system shown with a conventional transparent media adapter operable to scan images on transparent media as is known in the prior art;

FIG. 2A is a cross sectional view of an exemplary embodiment of a media adapter according to the teachings of the invention;

FIGS. 2B and 2C are side views of a media roll mounted in the media adapter of FIG. 2A having different portions of the media roll exposed for scanning according to the teachings of the invention;

FIG. 3 is an elevational view of a scanner system coupled to a computer according to the teachings of the invention; and

FIG. 4 is a cross sectional view of the scanner system coupled to a computer according to the teachings of the invention.

### DETAILED DESCRIPTION OF THE DRAWINGS

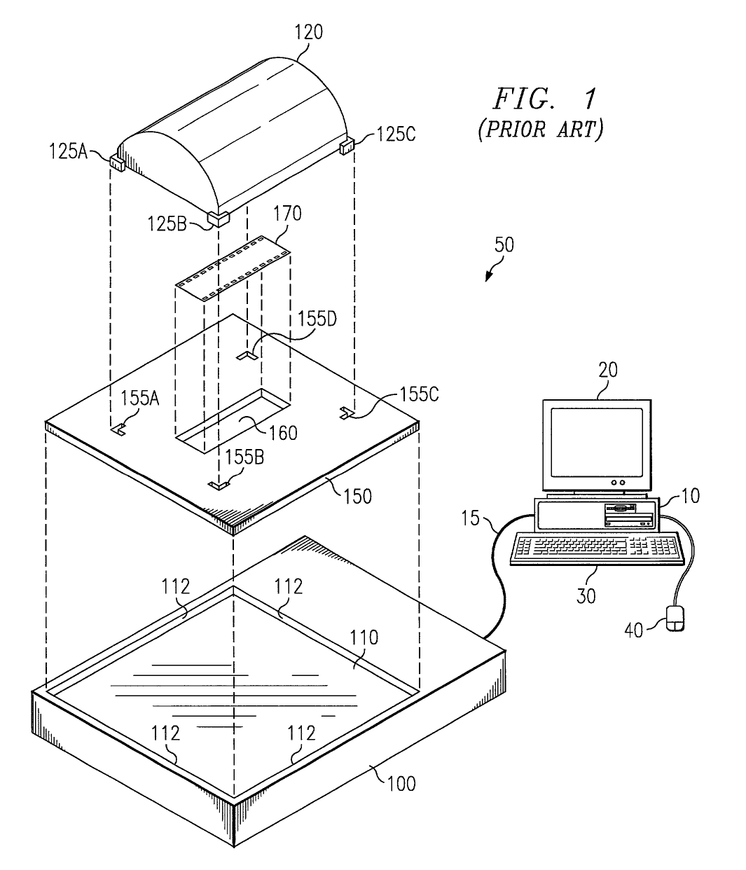

The preferred embodiment of the present invention and its advantages are best understood by referring to FIGS. 1 through 4 of the drawings, like numerals being used for like and corresponding parts of the various drawings.

Referring to FIG. 1, there is illustrated a document scanner system 50 connected to a computer 10 and operable to scan both opaque and transparent media as is known in the prior art. Document scanner system 50 includes a reflective scanner 100 that includes a transparent platen 110 on which the document to be scanned is placed. Scanner 100 generally includes a cover (not shown) or similar device that is placed over an opaque document prior to performing a reflective scan. A conventional transparent media adapter 120 may be used in conjunction with reflective scanner 100 for enabling reflective scanner 100 to scan images on a transparent media 170 such as photographic negatives and slides. A template 150 may be used to properly position transparent media 170 on platen 110. Template 150 may be dimensioned such that it fits securely within recessed edges 112 of reflective scanner 100 around platen 110. Template 150 may include one or more insert areas 160 for accommodating one or more transparent media 170 therein. Template 150 may include one or more alignment elements 155A-155D, such as recessions, ridges or apertures, that may be engaged with one or more positioning elements 125A-125C on adapter 120 to facilitate proper alignment and positioning of adapter 120 on template 150.

In order to scan an image on a transparent media, template 150 is securely placed on platen 110 and transparent media 170 is placed in insert area 160 of template 150. Transparent media adapter 120 is then positioned over template 150 and produces a backlight shining through transparent media 170 when the scanning operation is performed. A computer 10 may be coupled to, and facilitate control of, scanner system 50 via a cable 15 connecting a respective external peripheral interface, such as a parallel interface, a universal serial bus interface or other communications medium, of computer 10 and scanner 100. Computer 10 may include one or more input devices, such as a keyboard 30 and a mouse 40, that allow user interaction therewith and facilitate user control of scanner system 50. One or more output devices, such as a monitor 20, a printer (not shown), memory (not shown), data storage devices (not shown) and other devices, may allow transfer of data from the computer 10 to an external system.

Scanning images on a transparent media such as a roll of negatives with conventional scanning systems is time consuming. Conventional means require that the roll of film be cut into segments of a predefined number of frames, for example segments of three or four frames. According to these conventional systems, scanning an entire roll of 35 mm negatives requires each of these segments to be individually loaded into a template and scanned on a segment by segment basis. This generally requires manually loading a single segment of negatives into the insert area of the template, positioning the template on the scanner platen, placing the transparent media adapter on the template and performing the digital scan. Each segment of negatives is accordingly scanned and a full roll of film negatives can take up to ten or more scan operations to complete. The present invention allows a full roll of media to be scanned without requiring the roll to be cut into segments and eliminates the need for a template in performing the scan operation.

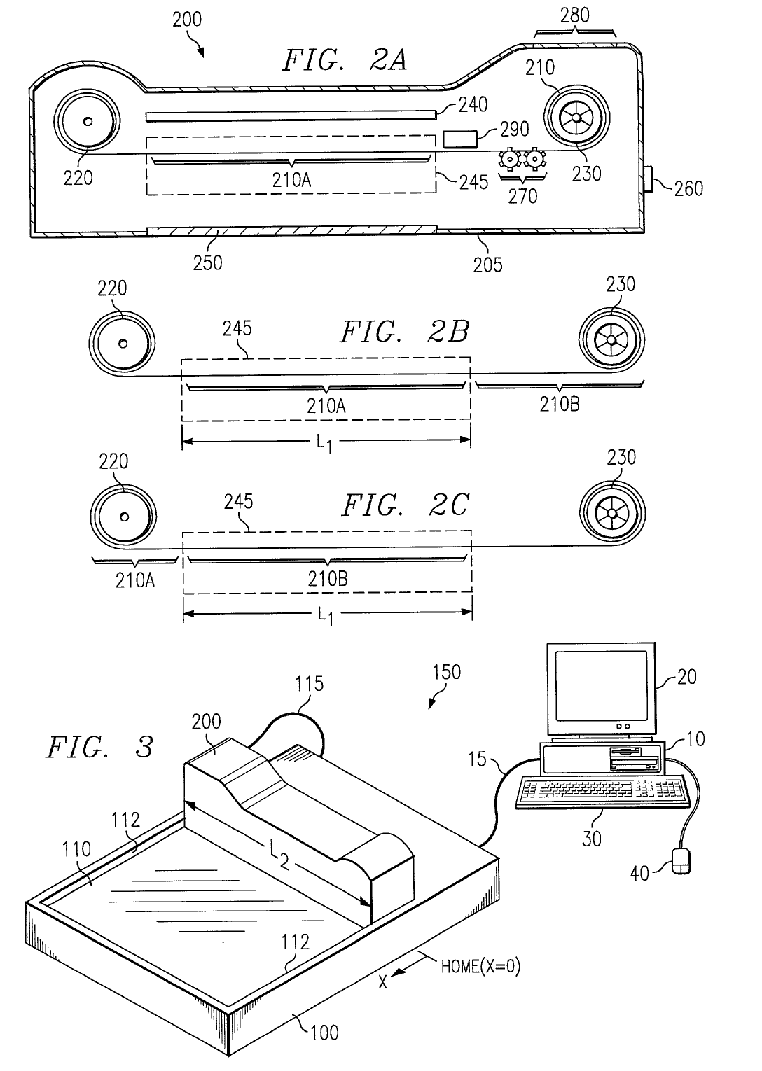

In FIG. 2A, there is illustrated a cross-sectional view of an exemplary embodiment of a media adapter 200 as provided by the teachings of the invention. Adapter 200 includes a media roll mount 230 for installing a media roll 210 thereon and a media gatherer 220. A translucent panel 250 is disposed on a bottom surface 205 of the adapter and allows light from an internal adapter lamp 240 that may be included within adapter 200 to pass therethrough. Inclusion of internal adapter lamp 240 within adapter 200 allows media adapter 200 to facilitate scanning of a media roll 210 of transparent media such as film negatives. Inclusion of adapter lamp 240 is preferable and allows scanning of either transparent media or opaque media. However, inclusion of adapter lamp 240 is not necessary to implement the teachings of the invention and an opaque media roll may be scanned according to the teachings herein in the absence of adapter lamp 240. A portion of the media is unwound from media roll 210 and connected to a media gatherer 220 thus leaving a portion 210A of the media suspended between adapter lamp 240 and translucent panel 250 and exposed within a scan area 245. As shown in FIG. 2B, at least one subsequent media portion 210B (or a part thereof) of media roll 210 is still partially wound about media roll 210. Scan area 245 is a region between adapter lamp 240 (or, alternatively, a region where adapter lamp 240 may be disposed) and translucent panel 250 in which an exposed portion of media roll 210 may be scanned. Media adapter 200 may, alternatively, be dimensioned such that subsequent portion 210B is fully unwound from media roll 210 but not positioned within scan area 245 while the preceding portion 210A is located within scan area 245. One or more media feed mechanisms 270 may be included in adapter 200 for advancing media roll 210, that is for transferring portion 210A of media roll 210 to media gatherer 220 such that subsequent portion 210B of media roll 210 is exposed within scan area 245 (FIG. 2C). A magnetic read and/or write head 290 may be included within media adapter 200 for reading and/or writing data, such as dates and other descriptive information associated with one or more frames of media roll 210, magnetically embedded within media roll 210. This information may then be transmitted to computer 10 and associated with imaged data obtained from scanning images on media roll 210.

Referring also to FIG. 3, adapter 200 may be positioned on platen 110 of scanner 100 for scanning images on media roll 210 contained within adapter 200. Bottom surface 205 of adapter 200 is placed against platen 110 in a scanner configuration for scanning images contained on frames of media roll 210. Adapter lamp 240 (not specifically shown in FIG. 3) may optionally be included to provide backlight illumination to portion 210A of a transparent media roll 210 exposed between adapter lamp 240 and translucent panel 250 within scan area 245. When adapter lamp 240 is activated, light radiating therefrom will pass through portion 210A of media roll 210 that is transparent and through translucent panel 250. An opaque media roll 210 may be scanned when adapter 200 includes adapter lamp 240 by deactivating adapter lamp 240 during a scan procedure. Opaque media is then scanned by illuminating the opaque media with a lamp internally disposed and activated within reflective scanner 100.

Adapter 200 may be connected to scanner 100 via one or more cables 115. Cable 115 may provide power to one or more lamps 240 and other internal electronics of adapter 200. Scanner 100 is connected to computer 10 via cable 15 over an external peripheral interface of computer 10 and reflective scanner 100 that provides a communication medium therebetween. Communication may also be made between adapter 200 and computer 10 via cables 115 and 15. Software executing on computer 10 may control various functions and provide directives to scanner 100 and adapter 200 that govern the operational behavior of scanner 100 and adapter 200. For example, activation or deactivation of a respective internal lamp within scanner 100 and adapter lamp 240, an exposure rate of image capture by scanner 100 and other scanning parameters may be controlled by computer 10. Software executed on computer 10 may also include one or more programs for processing imaged data, for example code that directs inversion processing of scanned images on computer 10.

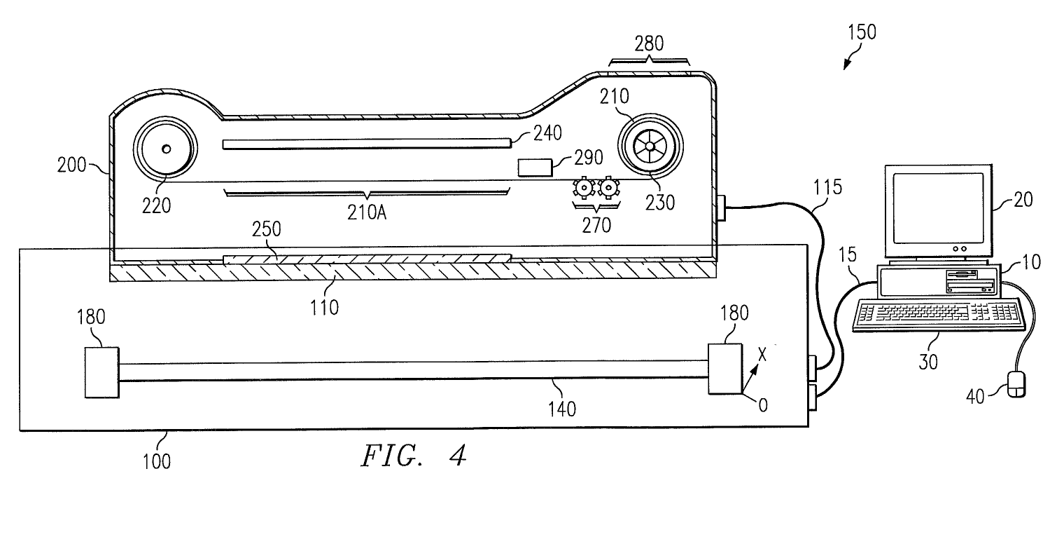

Referring to both FIGS. 3 and 4, media roll 210 has a portion 210A unwound, or unspooled, and an end thereof connected to media gatherer 220. Portion 210A of media roll 210 is exposed and positioned between adapter lamp 240 and translucent panel 250. Media feed mechanism 270 performs media advance operations to advance media roll 210 such that exposed portion 210A of media roll 210 is spooled onto media gatherer 220. Each media advance operation may include advancing the media a predefined amount, or length (L₁) (not shown in FIG. 3 and 4), that corresponds with the length of media of a predefined number of frames thereof.

A carriage 180 may support various internal components and assemblies of scanner 100 such as scanner lamp 140, an optics system (not shown) and photosensitive devices such as CCDs (not shown). Carriage 180 provides a translational motion, for example in reference direction X, to the components supported thereby. Adapter lamp 240 of adapter 200 is generally activated when performing a scan of images on media roll 210 that is transparent. Preferably, scanner lamp 140 is deactivated during the scanning of media roll 210 that is transparent. Thus, light radiated from adapter lamp 240 will impinge and pass through portion 210A of media roll 210, through translucent panel 250 and through platen 110. The light is then gathered by an internal optic system in scanner 100 and directed to one or more photosensitive devices and converted to an electric signal. Adapter lamp 240 is generally maintained in an activated state while the optic and photosensitive devices traverse a distance of at least a length or width of a transparent media. In the example, carriage 180 preferably moves the optic and photosensitive devices secured thereto through a translational distance approximately equivalent to the length (L₂) of adapter 200 thereby ensuring that the entire exposed portion 210A is scanned. Media roll 210 that is opaque may be scanned by deactivating adapter lamp 240 and activating scanner lamp 140. Light radiated from scanner lamp 140 will impinge and reflect from portion 210A of media roll 210, pass through translucent panel 250 and through platen 110 where it is gathered by an internal optic system in scanner 100.

A user may initiate a media scan routine by interaction with a graphical user interface provided on monitor 20 and via an input device such as keyboard 30, mouse 40 or other device. Alternatively, a user may initiate a scan routine by interaction with an activation key/s that may be disposed on scanner 100 and/or media adapter 200. Upon initiation, computer 10 may communicate with scanner 100 and/or adapter 200 and provide directives thereto required for imaging transparent media such as media roll 210. Computer 10 may deactivate scanner lamp 140 and activate adapter lamp 240 (for scanning media roll 210 that is transparent) prior to activating carriage 180 and the photosensitive devices thereon, or computer 10 may activate scanner lamp 140 and deactivate adapter lamp 240 (for scanning media roll 210 that is opaque) prior to activating carriage 180 and the photosensitive devices thereon. Computer 10 or a software routine executing thereon is operable to instruct carriage 180 to travel and scan a predefined translation distance (X=L₂) approximately equal to the length of adapter 200. After completion of the scan operation, carriage 180 is returned to the home position (X=0). The imaging data is then transferred to computer 10 and maintained in a storage device. During the time from which the scan operation is completed and prior to a subsequent scan operation of additional frames of media roll 210, media feed mechanism 270 is instructed by computer 10 to perform a media advance operation in which portion 210A of media roll 210 is advanced, or spooled, onto media gatherer 220. Alternatively, media feed mechanism 270 may be initiated by a manual user input such as actuation of a key (not shown) disposed on media adapter 200. Accordingly, frames on media roll 210 become unspooled and exposed in scan area 245 after the media advance operation. Adapter 200 may transmit a signal that indicates the media advance operation has been completed to scanner 100 over cable 115 which, in turn, forwards the signal to computer 10 over an external peripheral interface via cable 15. Upon reception of the signal from adapter 200 and completion of carriage 180 return to the home position, computer 10 may direct scanner system 150 to perform a subsequent scan routine on newly exposed frames of media roll 210. This procedure may be repeated until all frames of media roll 210 have been scanned. Media feed mechanism 270 may then be instructed by computer 10 to reverse direction and rewind the entire media roll 210 on mount 230. Media roll 210 may then be removed via adapter lid 280.

As described, a media adapter operable to expose a portion of a media roll and automatically forward the media for exposing additional portions of the media is provided. A roll of media has an end thereof attached to a gatherer in the adapter. A feed mechanism forwards a predefined length of the media to expose sequential portions of the media. A scanner system for scanning images on a media roll includes a reflective scanner having an optic system and a photosensitive device and a media adapter including a mount for attaching a roll of media thereto and a gatherer for collecting portions of the media. A first portion of the media is exposed between the mount and the adapter, and light is impinged upon the exposed portion of the media and onto an optic system where it is imaged. A second portion of the media is automatically unspooled from the roll while the first portion is collected by the gatherer. The second portion then has light impinged thereon and onto the optic system where it is imaged. The procedure may be repeated until an entire roll of transparent or opaque media has been scanned.

What is claimed is:

1. An adapter for a scanning system, comprising:
a media roll mount operable to hold a roll of media;
a media gatherer operable to hold an end of the media;
an adapter body operable to house at least an exposed portion of the media between the media roll mount and the media gatherer; and
a media feed mechanism operable to perform a first feed operation including forwarding a predefined length of the media onto the media gatherer, the media feed mechanism operable to perform one or more subsequent feed operations to allow scanning of the entire roll of media.

2. The adapter according to claim 1, further comprising:
a lamp; and
a translucent panel on a bottom surface of the adapter body, the exposed portion being disposed between the lamp and the panel.

3. The adapter according to claim 1, further comprising a communication interface with a scanner, the scanner having a communication interface with a computer, the adapter operable to transmit and receive communications with the scanner and the computer.

4. The adapter according to claim 3, wherein the adapter is operable to transmit a signal to the computer upon completion of each of the feed operations.

5. The adapter according to claim 3, further comprising:
a lamp; and
a translucent panel on a bottom surface of the adapter body, the exposed portion being disposed between the lamp and the panel, the adapter operable to activate and deactivate the lamp upon command of the computer.

6. The adapter according to claim 1, further comprising a magnetic read head operable to read embedded data on the roll of media.

7. The adapter according to claim 1, further comprising a magnetic write head operable to write data on the roll of media.

8. A method of scanning images on a media, comprising:
exposing a first portion having a predefined length of the media to an illumination source;
impinging light on the first portion of the media;
advancing the media by the predefined length to expose a subsequent portion having the predefined length of the media to the illumination source; and
repeating the light impinging and media advancing steps.

9. The method according to claim 8, wherein exposing a first portion of the transparent media comprises exposing a first portion of a roll of photographic negatives.

10. The method according to claim 9, wherein impinging light on the first portion of the media further comprises transmitting light from the illumination source onto the first portion, the light transmitted onto the first portion passing therethrough, the illumination source disposed within an adapter containing the media.

11. The method according to claim 8, further comprising converting the light impinging on each exposed portion of the transparent media into electric signals.

12. The method according to claim 8, further comprising:
displacing a carriage supporting the photosensitive device receiving the impinging light from a home position to a second position; and
returning the carriage to the home position prior to receiving light through the subsequent portion.

13. The method according to claim 12, wherein advancing the media by the predefined length comprises advancing the media by a length substantially equivalent to the combined length of an integer number of image frames.

14. The method according to claim 8, wherein impinging light on the first portion of the media further comprises reflecting light off of the first portion, the illumination source disposed within a reflective scanner, the light reflected off of the first portion radiated from the illumination source.

15. A scanner system for scanning an image on a media, comprising:
a reflective scanner including a platen, a scanner lamp, an optic system and one or more photosensitive devices; and
a media adapter including a mount operable to hold a roll of media, a gatherer operable to hold an end of the media, an adapter body operable to house at least an exposed portion of the media between the mount and the gatherer, and a media feed mechanism operable to perform a first feed operation including forwarding a predefined length of the media onto the gatherer, the media feed mechanism operable to perform one or more subsequent feed operations to allow scanning of the entire roll of media by the reflective scanner.

16. The system according to claim 13, wherein the scanner further includes an external peripheral interface, the system communicates with a computer connected to the scanner by the external peripheral interface, the adapter connected to the scanner by a cable, the computer having an input device for a user interaction therewith, the user initiating scanning of images on the media by providing a command to the computer, the computer directing operation of the scanner system in response to receiving the command.

17. The system according to claim 14, wherein the optic system and the one or more photosensitive devices are located on a carriage operable to impart a translation motion thereto, the carriage moving from a home position to a second position while the adapter transmits light through the exposed portion of the media, the adapter transmitting a signal to the computer after performing the first feed operation, the carriage returning to the home position after reaching the second position, the computer commanding the carriage to return to the second position after receiving the signal from the adapter.

18. The system according to claim 13, wherein the media is a transparent media, the adapter further includes an adapter lamp, the scanner further includes an external peripheral interface, the system communicates with a computer connected to the scanner by the external peripheral interface, the adapter connected to the scanner by a cable, the computer having an input device for a user interaction therewith, the user initiating scanning of images on the exposed portion by providing a command to the computer, the computer directing activation of the adapter lamp and deactivation of the scanner lamp upon input of the command.

19. The system according to claim 13, wherein the media is an opaque media, the adapter further includes an adapter lamp, the scanner further includes an external peripheral interface, the system communicates with a computer connected to the scanner by the external peripheral interface, the adapter connected to the scanner by a cable, the computer having an input device for a user interaction therewith, the user initiating scanning of images on the exposed portion by providing a command to the computer, the computer directing deactivation of the adapter lamp and activation of the scanner lamp upon input of the command.
